(19) United States
(12) Patent Application Publication
(10) Pub. No.: US 2022/0065708 A1
(43) Pub. Date: Mar. 3, 2022

(54) TEMPERATURE SENSOR ELEMENT

(71) Applicant: SUMITOMO CHEMICAL COMPANY, LIMITED, Tokyo (JP)

(72) Inventors: Megumi HAYASAKA, Osaka-shi (JP); Yuichiro KUNAI, Toyonaka-shi (JP)

(73) Assignee: SUMITOMO CHEMICAL COMPANY, LIMITED, Tokyo (JP)

(21) Appl. No.: 17/419,567

(22) PCT Filed: Mar. 4, 2020
(86) PCT No.: PCT/JP2020/009085

§ 371 Date: Jun. 29, 2021

(30) Foreign Application Priority Data
Mar. 29, 2019 (JP) 2019-068130

(51) Int. Cl. G01K 7/22; C08L 79/08; H01C 7/04; H01C 1/14

(52) U.S. Cl. CPC G01K 7/22; C08L 79/08; C08L 2203/20; H01C 1/1413; C08L 2203/16; H01C 7/049

(57) ABSTRACT

There is provided a temperature sensor element including a pair of electrodes and a temperature-sensitive film disposed in contact with the pair of electrodes, in which the temperature-sensitive film includes a fluorine atom and the temperature-sensitive film includes a matrix resin and a plurality of conductive domains contained in the matrix resin, and the conductive domains includes a conductive polymer.

### TECHNICAL FIELD

The present invention relates to a temperature sensor element.

### BACKGROUND ART

There has been conventionally known a thermistor-type temperature sensor element including a temperature-sensitive film changed in electric resistance value due to the change in temperature. An inorganic semiconductor thermistor has been conventionally used in the temperature-sensitive film of such a thermistor-type temperature sensor element. Such an inorganic semiconductor thermistor is hard, and thus a temperature sensor element using the same is usually difficult to have flexibility.

Japanese Patent Laid-Open No. H3-255923 (Patent Literature 1) relates to a thermistor-type infrared detection element using a polymer semiconductor having NTC characteristics (Negative Temperature Coefficient; characteristics of the reduction in electric resistance value due to the rise in temperature). The infrared detection element detects infrared light by detecting the rise in temperature due to incident infrared light, in terms of the change in electric resistance value, and includes a pair of electrodes and a thin film including the polymer semiconductor containing an electronically conjugated organic polymer partially doped, as a component.

### CITATION LIST

### Patent Literature

Patent Literature 1: Japanese Patent Laid-Open No. H3-255923

### SUMMARY OF INVENTION

### Technical Problem

The thin film in the infrared detection element disclosed in Patent Literature 1 is formed by an organic substance, and thus flexibility can be imparted to the infrared detection element.

However, Patent Literature 1 does not consider any suppression of the variation in instruction value (stability of instruction value) due to the change in humidity environment where the infrared detection element is placed. The instruction value is also referred to as “electric resistance value”.

An object of the present invention is to provide a thermistor-type temperature sensor element including a temperature-sensitive film including an organic substance, in which the temperature sensor element is hardly affected by a humidity environment where the element is placed, and can be suppressed in variation in electric resistance value due to the change in humidity environment.

### Solution to Problem

The present invention provides the following temperature sensor element.

[1] A temperature sensor element including a pair of electrodes and a temperature-sensitive film disposed in contact with the pair of electrodes, wherein

the temperature-sensitive film includes a fluorine atom and the temperature-sensitive film includes a matrix resin and a plurality of conductive domains contained in the matrix resin, and

the conductive domains include a conductive polymer.

[2] The temperature sensor element according to [1], wherein the matrix resin contains a fluorine atom.

[3] The temperature sensor element according to [1] or [2], wherein a content rate of a fluorine atom in the temperature-sensitive film is 1% by mass or more based on a total mass of a temperature-sensitive film 103 of 100% by mass.

[4] The temperature sensor element according to any of [1] to [3], wherein a content rate of fluorine in the matrix resin is 4% by mass or more based on a total mass of the matrix resin of 100% by mass included in the temperature-sensitive film.

[5] The temperature sensor element according to any of [1] to [4], wherein the matrix resin includes a polyimide-based resin component.

[6] The temperature sensor element according to [5], wherein a content rate of a phthalimide ring in the polyimide-based resin component is 5% by mass or more based on a total mass of the polyimide-based resin component of 100% by mass.

### Advantageous Effect of Invention

There can be provided a temperature sensor element that is hardly affected by a humidity environment where the element is placed and that can be suppressed in variation in electric resistance value due to the change in humidity environment.

### BRIEF DESCRIPTION OF DRAWINGS

FIG. 1 is a schematic top view illustrating one example of the temperature sensor element according to the present invention.

FIG. 2 is a schematic cross-sectional view illustrating one example of the temperature sensor element according to the present invention.

FIG. 3 is a schematic top view illustrating a method of producing a temperature sensor element of Example 1.

FIG. 4 is a schematic top view illustrating the method of producing the temperature sensor element of Example 1.

FIG. 5 is a SEM photograph of a temperature-sensitive film included in the temperature sensor element of Example 1.

### DESCRIPTION OF EMBODIMENTS

The temperature sensor element according to the present invention (hereinafter, also simply referred to as “temperature sensor element”.) includes a pair of electrodes and a temperature-sensitive film disposed in contact with the pair of electrodes.

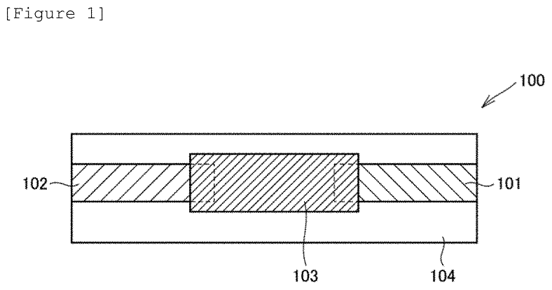

FIG. 1 is a schematic top view illustrating one example of the temperature sensor element. A temperature sensor element 100 illustrated in FIG. 1 includes a pair of electrodes of a first electrode 101 and a second electrode 102, and a temperature-sensitive film 103 disposed in contact with both the first electrode 101 and the second electrode 102. The temperature-sensitive film 103, both ends of which are formed on the first electrode 101 and the second electrode 102, respectively, is thus in contact with such electrodes.

The temperature sensor element can further include a substrate 104 that supports the first electrode 101, the second electrode 102 and the temperature-sensitive film 103 (see FIG. 1).

The temperature sensor element 100 illustrated in FIG. 1 is a thermistor-type temperature sensor element where the temperature-sensitive film 103 detects the change in temperature, as an electric resistance value.

The temperature-sensitive film 103 has NTC characteristics that exhibit a decrease in electric resistance value due to the rise in temperature.

### [1] First Electrode and Second Electrode

The first electrode 101 and the second electrode 102 here used are sufficiently small in electric resistance value as compared with the temperature-sensitive film 103. The respective electric resistance values of the first electrode 101 and the second electrode 102 included in the temperature sensor element are specifically preferably 500Ω or less, more preferably 200Ω or less, further preferably 100Ω or less at a temperature of 25° C.

The respective materials of the first electrode 101 and the second electrode 102 are not particularly limited as long as a sufficiently small electric resistance value is obtained as compared with that of the temperature-sensitive film 103, and such each material can be, for example, a metal single substance such as gold, silver, copper, platinum, or palladium; an alloy including two or more metal materials; a metal oxide such as indium tin oxide (ITO) or indium zinc oxide (IZO); or a conductive organic substance (for example, a conductive polymer).

The material of the first electrode 101 and the material of the second electrode 102 may be the same as or different from each other.

The respective methods of forming the first electrode 101 and the second electrode 102 are not particularly limited, and may be each a common method such as vapor deposition, sputtering, or coating (coating method). The first electrode 101 and the second electrode 102 can be each formed directly on the substrate 104.

The respective thicknesses of the first electrode 101 and the second electrode 102 are not particularly limited as long as a sufficiently small electric resistance value is obtained as compared with that of the temperature-sensitive film 103, and such each thickness is, for example, 50 nm or more and 1000 nm or less, preferably 100 nm or more and 500 nm or less.

### [2] Substrate

The substrate 104 is a support that supports the first electrode 101, the second electrode 102 and the temperature-sensitive film 103.

The material of the substrate 104 is not particularly limited as long as the material is non-conductive (insulating), and the material can be, for example, a resin material such as a thermoplastic resin or an inorganic material such as glass. In a case where a resin material is used in the substrate 104, the temperature-sensitive film 103 typically has flexibility and thus flexibility can be imparted to the temperature sensor element.

The thickness of the substrate 104 s preferably set in consideration of flexibility, durability, and the like of the temperature sensor element. The thickness of the substrate 104 is, for example, 10 μm or more and 5000 μm or less, preferably 50 μm or more and 1000 μm or less.

### [3] Temperature-Sensitive Film

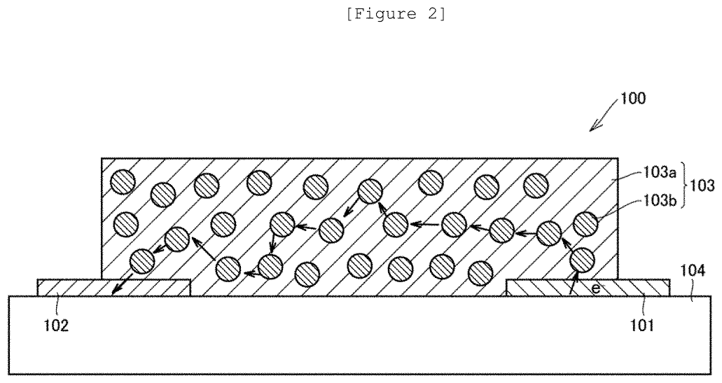

FIG. 2 is a schematic cross-sectional view illustrating one example of the temperature sensor element. A temperature-sensitive film 103 includes a matrix resin 103a and a plurality of conductive domains 103b contained in the matrix resin 103a in the temperature sensor element according to the present invention, as in a temperature sensor element 100 illustrated in FIG. 2. The plurality of conductive domains 103b are preferably dispersed in the matrix resin 103a.

The conductive domains 103b refer to a plurality of regions in the temperature-sensitive film 103 included in the temperature sensor element, which are contained in the matrix resin 103a and which contribute to electron transfer. The conductive domains 103b include a conductive polymer and are preferably formed by a conductive polymer.

The temperature-sensitive film 103 contains a fluorine atom. The “temperature-sensitive film 103 containing a fluorine atom” refers to the presence of a fluorine atom in the temperature-sensitive film. Such a temperature-sensitive film 103 containing a fluorine atom can allow penetration of moisture into the temperature-sensitive film 103 to be suppressed. Such suppression of penetration of moisture into the temperature-sensitive film 103 can also contribute to suppression of deterioration in measurement accuracy as indicated in the following 1) and 2).

1) If moisture is diffused in the temperature-sensitive film 103, an ion channel with water tends to be formed to result in an increase in electric conductivity due to ion conduction or the like. Such a temperature-sensitive film 103 that can allow penetration of moisture into the temperature-sensitive film 103 to be suppressed can allow an increase in electric conductivity due to moisture diffused into the temperature-sensitive film 103 to be suppressed.

2) If moisture is diffused in the temperature-sensitive film 103, the matrix resin 103a tends to be swollen to result in an increase in distance between the conductive domains 103b. This leads to an increase in electric resistance value detected by the temperature sensor element. Such a temperature-sensitive film 103 that can allow penetration of moisture into the temperature-sensitive film 103 to be suppressed can allow a decrease in electric conductivity due to moisture diffused into the temperature-sensitive film 103 to be suppressed.

As described above, the temperature sensor element including the temperature-sensitive film 103 containing a fluorine atom is hardly affected by a humidity environment where the element is placed, and can be suppressed in variation in electric resistance value due to the change in humidity environment. The temperature-sensitive film 103 is suppressed in penetration of moisture into the temperature-sensitive film 103 under a high humidity environment, and thus, even in a case where the temperature sensor element is placed, for example, under a high humidity environment and then placed in a lower humidity environment, the numerical value of the electric resistance value at a certain temperature tends to be hardly varied (different).

The content rate of a fluorine atom (hereinafter, also referred to as “content rate of fluorine”.) in the temperature-sensitive film 103 is preferably 1% by mass or more. The “content rate of fluorine in the temperature-sensitive film 103” means the proportion (% by mass) of the total mass of a fluorine atom in the temperature-sensitive film 103 based on the total mass of the temperature-sensitive film of 100% by mass.

The content rate of fluorine in the temperature-sensitive film 103 is preferably adjusted depending on the humidity environment where the temperature sensor element is placed. In a case where the temperature sensor element is placed in a relatively high humidity environment, the content rate of fluorine in the temperature-sensitive film 103 is more preferably 2% by mass or more, further preferably 3% by mass or more, still further preferably 4% by mass or more, particularly preferably 5% by mass or more, most preferably 10% by mass or more. In a case where the temperature sensor element is placed in a humidity environment where condensation occurs on the surface of the element, the content rate of fluorine in the matrix resin 103a is preferably 4% by mass or more. On the other hand, if the content rate of fluorine is more than 40% by mass, adhesiveness between the substrate and the temperature-sensitive film 103 or the electrodes and the temperature-sensitive film 103 is deteriorated and peeling easily occurs, thereby not only leading to deterioration in long-term stability of the temperature sensor element, but also leading to a short binding distance of a carbon-fluorine bond to thereby cause the temperature-sensitive film 103 to be rigid, resulting in deterioration in flexibility. The content rate of fluorine in the temperature-sensitive film 103 can be calculated in the same manner as in calculation of the content rate of fluorine in the matrix resin, described below, and may be calculated as the content of a fluorine atom relative to the mass of the temperature-sensitive film.

### [3-1] Conductive Polymer

The conductive polymer included in the conductive domains 103b includes a conjugated polymer and a dopant, and is preferably a conjugated polymer doped with a dopant.

A conjugated polymer by itself is usually extremely low in electric conductivity, and exhibits almost no electric conducting properties, for example, which correspond to 1×10⁻⁶ S/m or less. The reason why a conjugated polymer by itself is low in electric conductivity is because the valance band is saturated with electrons and such electrons cannot be freely transferred. On the other hand, a conjugated polymer, in which electrons are delocalized, is thus remarkably low in ionization potential and very large in electron affinity as compared with a saturated polymer. Accordingly, a conjugated polymer easily allows charge transfer with an appropriate dopant such as an electron acceptor (acceptor) or an electron donor (donor) to occur, and such a dopant can withdraw an electron from the valance band of such a conjugated polymer or inject an electron to the conduction band thereof. Thus, such a conjugated polymer doped with a dopant, namely, the conductive polymer can have a few holes present in the valance band or a few electrons present in the conduction band to allow such holes and/or electrons to be freely transferred, and thus tends to be drastically enhanced in conductive properties.

The conductive polymer, which is a single substance, preferably has a value of linear resistance R in the range of 0.01Ω or more and 300 MΩ or less at a temperature of 25° C., as measured with an electric tester at a distance between lead bars of several mm to several cm.

The conjugated polymer constituting the conductive polymer is one having a conjugated structure in its molecule, and examples include a polymer having a backbone where a double bond and a single bond are alternately linked, and a polymer having an unshared pair of electrons conjugated.

Such a conjugated polymer can easily impart electric conducting properties by doping, as described above.

The conjugated polymer is not particularly limited, and examples thereof include polyacetylene; poly(p-phenylenevinylene); polypyrrole; polythiophene-based polymers such as poly(3,4-ethylenedioxythiophene) [PEDOT]; and polyaniline-based polymers (for example, polyaniline, and polyaniline having a substituent). The polythiophene-based polymer here means, for example, polythiophene, a polymer having a polythiophene backbone and having a side chain into which a substituent is introduced, and a polythiophene derivative. The “-based polymer” mentioned herein means a similar molecule.

The conjugated polymer may be used singly or in combinations of two or more kinds thereof.

The conjugated polymer is preferably a polyaniline-based polymer from the viewpoint of easiness of polymerization and identification.

Examples of the dopant include a compound serving as an electron acceptor (acceptor) from the conjugated polymer and a compound serving as an electron donor (donor) to the conjugated polymer.

The dopant serving as an electron acceptor is not particularly limited, and examples thereof include halogen such as Cl₂, Br₂, I₂, ICl₂, IBr, and IF₃; Lewis acids such as PF₅, AsF₅, SbF₅, BF₃, and SO₃; proton acids such as HCl, H₂SO₄, and HClO₄; transition metal halides such as FeCl₃, FeBr₃, and SnCl₄; and organic compounds such as tetracyanoethylene (TONE), tetracyanoquinodimethane (TCNQ), 2,3-dichloro-5,6-dicyano-p-benzoquinone (DDQ), amino acids, polystyrenesulfonic acid, p-toluenesulfonic acid, and camphorsulfonic acid.

The dopant serving as an electron donor is not particularly limited, and examples thereof include alkali metals such as Li, Na, K, Rb, and Cs; alkali earth metals such as Be, Mg, Ca, Sc, Ba, Ag, Eu, and Yb, or other metals.

The dopant is preferably selected appropriately depending on the type of the conjugated polymer.

The dopant may be used singly or in combinations of two or more kinds thereof.

The content of the dopant in the temperature-sensitive film 103 is preferably 0.1 mol or more, more preferably 0.4 mol or more based on 1 mol of the conjugated polymer, from the viewpoint of conductive properties of the conductive polymer. The content is preferably 3 mol or less, more preferably 2 mol or less based on 1 mol of the conjugated polymer.

The content of the dopant in the temperature-sensitive film 103 is preferably 1% by mass or more, more preferably 3% by mass or more based on the mass of the temperature-sensitive film of 100% by mass, from the viewpoint of conductive properties of the conductive polymer. The content is preferably 60% by mass or less, more preferably 50% by mass or less relative to the temperature-sensitive film.

The electric conductivity of the conductive polymer is obtained by combining the electronic conductivity in a molecular chain, the electronic conductivity between molecular chains, and the electronic conductivity between fibrils.

Carrier transfer is generally described by a hopping conduction mechanism. An electron present at a localized level in a non-crystalline region can be jumped to an adjacent localized level by the tunneling effect, in a case where the distance between localized states is short. In a case where there is a difference in energy between localized states, a thermal excitation process depending on the difference in energy is required. The conduction due to tunneling with such a thermal excitation process corresponds to hopping conduction.

In a case where the density of states is high at a low temperature or in the vicinity of the Fermi level, hopping to a distal level, small in difference in energy, is more dominant than hopping to a proximal level, large in difference in energy. In such a case, a variable range hopping conduction model (Mott-VRH model) is applied.

As can be understood from a variable range hopping conduction model (Mott-VRH model), the conductive polymer has NTC characteristics that exhibit a decrease in electric resistance value due to the rise in temperature.

### [3-2] Matrix Resin

The temperature-sensitive film includes a matrix resin and a conductive polymer. Specifically, the film includes a matrix resin and a plurality of conductive domains including a conductive polymer contained in the matrix resin. The plurality of conductive domains 103b are preferably dispersed in the matrix resin 103a. The matrix resin 103a is a matrix that fixes the plurality of conductive domains 103b into the temperature-sensitive film 103.

The plurality of conductive domains 103b including the conductive polymer can be contained in, preferably dispersed in the matrix resin 103a, thereby allowing the distance between the conductive domains to be increased to some extent. Thus, the electric resistance detected by the temperature sensor element can be any electric resistance mainly derived from hopping conduction (electron transfer indicated by an arrow in FIG. 2) between the conductive domains. Such hopping conduction is highly dependent on the temperature, as can be understood from a variable range hopping conduction model (Mott-VRH model). Accordingly, such hopping conduction can be dominant to result in an enhancement in temperature dependence of the electric resistance value exhibited by the temperature-sensitive film 103.

The plurality of conductive domains 103b including the conductive polymer are contained in, preferably dispersed in the matrix resin 103a, resulting in a tendency to obtain a temperature sensor element that hardly causes defects such as cracks to occur in the temperature-sensitive film 103 in use of the temperature sensor element and that has such a temperature-sensitive film 103 excellent in stability over time.

The temperature-sensitive film contains a fluorine atom, and in particular, the matrix resin 103a preferably contains a fluorine atom. The “matrix resin 103a containing a fluorine atom” refers to the presence of a fluorine atom in a polymer structure of the matrix resin. Such a matrix resin containing a fluorine atom can surround the conductive domains, thereby efficiently suppressing penetration of water. The matrix resin 103a can contain a fluorine atom, resulting in introduction of a fluorine atom without any loss of conductive properties of the conductive polymer.

Such a temperature-sensitive film 103 using the matrix resin 103a containing a fluorine atom can allow penetration of moisture into the temperature-sensitive film 103 to be suppressed. Such suppression of penetration of moisture into the temperature-sensitive film 103 can also contribute to suppression of deterioration in measurement accuracy as indicated in the above 1) and 2).

As described above, the temperature sensor element including the temperature-sensitive film 103 containing a fluorine atom is suppressed in penetration of moisture into the temperature-sensitive film 103 and thus is hardly affected by a humidity environment where the element is placed, and can be suppressed in variation in electric resistance value due to the change in humidity environment. Accordingly, even in a case where the temperature sensor element is placed, for example, under a high humidity environment and then placed in a lower humidity environment, the numerical value of the electric resistance value at a certain humidity tends to be hardly varied (different). That is, the temperature sensor element can more accurately measure the temperature with no influence by any humidity.

The content rate of a fluorine atom (hereinafter, also referred to as “content rate of fluorine”.) in the matrix resin 103a is preferably 4% by mass or more. The “content rate of fluorine in the matrix resin 103a” means the proportion (% by mass) of the total mass of a fluorine atom in the matrix resin 103a constituting the temperature-sensitive film 103 based on the total mass of the matrix resin of 100% by mass. In a case where the matrix resin 103a constituting the temperature-sensitive film 103 includes two or more resins, the total mass of such resins is assumed to be 100% by mass.

The content rate of fluorine in the matrix resin 103a can be measured according to the following method. In a case where the structure of the structural unit or the repeating unit can be specified, for example, the matrix resin is produced, the content rate of fluorine can be determined by calculating the content rate of a fluorine atom in the structure relative to the amount of all atoms in the structure, based on the structure. The repeating unit here means a structure of polyimide repeated in a polyimide resin, namely, a structure where structural units derived from raw material components such as diamine and tetracarboxylic acid described below are bound.

In a case where the structure of the matrix resin can be specified by structural analysis, the content rate of fluorine can be determined by calculating the content rate of a fluorine atom in such a structure specified, of the matrix resin, relative to the amount of all atoms in the structure, based on the structure. In a case where no structure of the matrix resin can be specified, measurement can be made according to a known combustion ion chromatographic method or the like. Specifically, a predetermined amount of the matrix resin is combusted under an air atmosphere or under an oxygen atmosphere (for example, at a concentration of oxygen of about 75%), and the gas generated is absorbed in an adsorption liquid such as an aqueous sodium hydroxide solution. Next, the adsorption liquid is subjected to measurement by ion chromatography, and thus the content rate of a fluorine atom in the matrix resin subjected to measurement can be determined. The adsorption liquid may be, if necessary, subjected to a reduction treatment.

The content rate of fluorine in the matrix resin 103a is preferably adjusted depending on the humidity environment where the temperature sensor element is placed. In a case where the temperature sensor element is placed in a relatively high humidity environment, the content rate of fluorine in the matrix resin 103a is more preferably 6% by mass or more, further preferably 10% by mass or more, still further preferably 15% by mass or more, particularly preferably 20% by mass or more. In a case where the temperature sensor element is placed in a humidity environment where condensation occurs on the surface of the element, the content rate of fluorine in the matrix resin 103a is preferably 15% by mass or more.

The content rate of fluorine in the matrix resin 103a is usually 50% by mass or less. The content rate is preferably 45% by mass or less, more preferably 40% by mass or less from the viewpoint of adhesiveness to the substrate, and adhesiveness of the substrate and the electrodes.

The matrix resin 103a is not particularly limited as long as the matrix resin 103a contains a fluorine atom as a whole, and examples include a cured product of an active energy ray-curable resin, a cured product of a thermosetting resin, and a thermoplastic resin. In particular, a thermoplastic resin is preferably used.

In a case where the matrix resin 103a is constituted by one resin, the resin preferably contains a fluorine atom. In a case where the matrix resin 103a is constituted by two or more resins, at least one resin preferably contains a fluorine atom.

The thermoplastic resin is not particularly limited, and examples thereof include polyolefin-based resins such as polyethylene and polypropylene; polyester-based resins such as polyethylene terephthalate; polycarbonate-based resins; (meth)acrylic resins; cellulose-based resins; polystyrene-based resins; polyvinyl chloride-based resins; acrylonitrile-butadiene s-tyrene-based resins; acrylonitrile-styrene-based resins; polyvinyl acetate-based resins; polyvinylidene chloride-based resins; polyamide-based resins; polyacetal-based resins; modified polyphenylene ether-based resins; polysulfone-based resins; polyethersulfone-based resins; polyarylate-based resins; and polyimide-based resins such as polyimide and polyamideimide. Such thermoplastic resins may each contain a fluorine atom.

In particular, the matrix resin 103a is preferably high in polymer packing properties (also referred to as “molecular packing properties”). Such a matrix resin 103a high in molecular packing properties is used to thereby enable penetration of moisture into the temperature-sensitive film 103 to be more effectively suppressed. Such a matrix resin 103a high in molecular packing properties is used to result in a tendency to more effectively suppress the variation in electric resistance value due to the change in humidity environment.

Such molecular packing properties are based on intermolecular interaction. Accordingly, one solution to enhance molecular packing properties of the matrix resin 103a is to introduce a functional group or moiety that easily results in intermolecular interaction, into a polymer chain.

Examples of the functional group or moiety include functional groups each capable of forming a hydrogen bond, such as a hydroxyl group, a carboxyl group, and an amino group, and functional groups or moieties (for example, moieties such as an aromatic ring) each capable of allowing π-π stacking interaction to occur.

In particular, in a case where a polymer capable of allowing π-π stacking interaction to occur is used in the matrix resin 103a, packing due to π-π stacking interaction is easily uniformly extended to the entire molecule and thus penetration of moisture into the temperature-sensitive film 103 can be more effectively suppressed.

In a case where a polymer capable of allowing π-π stacking interaction to occur is used in the matrix resin 103a, a moiety allowing intermolecular interaction to occur is hydrophobic and thus penetration of moisture into the temperature-sensitive film 103 can be more effectively suppressed.

A crystalline resin and a liquid crystalline resin also each have a highly ordered structure, and thus are each suitable as the matrix resin 103a high in molecular packing properties.

The matrix resin 103a preferably includes a polyimide-based resin component from the viewpoint of heat resistance of the temperature-sensitive film 103, film formability of the temperature-sensitive film 103, and the like. The polyimide-based resin component more preferably includes an aromatic polyimide-based resin containing an aromatic ring because π-π stacking interaction easily occurs. The aromatic polyimide-based resin preferably includes an aromatic ring in a main chain.

The polyimide-based resin component refers to a polyimide resin included in a resin composition. That is, in a case where a polyimide resin component includes one polyimide resin, a polyimide resin component contained in a resin composition means such one polyimide resin, and in a case where a polyimide resin component includes two or more polyimide resins, a polyimide resin component contained in a resin composition means such two or more polyimide resins.

The polyimide-based resin component preferably includes one or more fluorinated polyimide-based resins that allow the matrix resin 103a to contain a fluorine atom. Herein, in a case where the matrix resin 103a further includes a resin component other than the polyimide-based resin component, at least any one of the polyimide-based resin component and such other resin component may contain a fluorine atom.

In a case where the matrix resin 103a includes the polyimide-based resin component, the matrix resin 103a may be constituted from only the polyimide-based resin component, or may further include any other resin component.

The matrix resin 103a preferably includes 50% by mass or more of the polyimide-based resin component based on the total of the resin component(s) of 100% by mass constituting the matrix resin, from the viewpoint of heat resistance of the temperature-sensitive film 103, film formability of the temperature-sensitive film 103, and the like, and from the viewpoint of molecular packing properties of the matrix resin 103a. The content of the matrix resin 103a is more preferably 70% by mass or more, further preferably 90% by mass or more, still further preferably 95% by mass or more, particularly preferably 100% by mass.

The polyimide-based resin component includes a phthalimide ring as the aromatic ring, and the content rate of such a phthalimide ring (hereinafter, also referred to as “content rate of a phthalimide ring”.) is preferably 5% by mass or more. The content rate of a phthalimide ring means the proportion (% by mass) of the total mass of a phthalimide ring based on the total mass (100% by mass) of the polyimide-based resin component.

In a case where a polyimide-based resin component in which the content rate of a phthalimide ring is 5% by mass or more is used as a part or the whole of the matrix resin 103a, a phthalimide ring significantly contributes to π-π stacking interaction and thus molecular packing properties of the matrix resin 103a can be enhanced.

The content rate of a phthalimide ring in the polyimide-based resin component is more preferably 10% by mass or more, further preferably 20% by mass or more, still further preferably 30% by mass or more, from the viewpoint of an enhancement in molecular packing properties due to π-π stacking interaction.

The content rate of a phthalimide ring is usually 60% by mass or less, more typically 50% by mass or less.

A phthalimide ring in the polyimide-based resin component is a structure represented by the following formula (i).

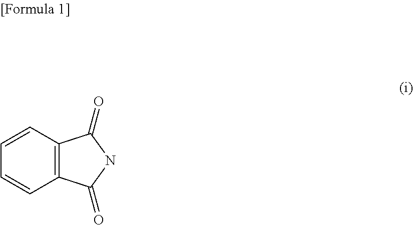 [SMILES: O=C1NC(=O)c2ccccc21]

A N atom, and any C atom forming a benzene ring in a phthalimide ring may be bound to a structural unit and/or substituent other than a phthalimide ring, in the polyimide-based resin. Here, no hydrogen atom may be bound to such N atom and C atom bound to such other structural unit and/or substituent. A phthalimide ring may be introduced into any one of or both a main chain and a side chain of the polyimide-based resin having a phthalimide ring, and is preferably introduced into the main chain. The main chain refers to the longest chain of the polyimide-based resin.

A phthalimide ring in the polyimide-based resin component preferably has a structure represented by the following formula (ii). In the formula, *1 and *2 each represent a bond with an adjacent main chain structure. In the formula (ii), the position of the bond represented by *2 is more preferably the 4-position or 5-position.

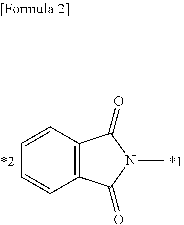

The content rate of a phthalimide ring can be calculated from the expression “Total mass of phthalimide ring/Total mass of polyimide-based resin component”, and can be calculated based on, for example, the molecular weight of the repeating unit in the polyimide-based resin constituting the polyimide-based resin component and the molecular weight of a phthalimide ring included in the repeating unit.

The molecular weight of such one phthalimide ring is 145 regardless of the number of bonds in a structural unit other than such a phthalimide ring in the polyimide-based resin, and the number of bonds in a substituent, in such a phthalimide ring. In the case of a structure where a plurality of such phthalimide rings share one side of such each phthalimide ring and thus are fused, each of such phthalimide rings fused is counted as a phthalimide ring and the molecular weight of each of such phthalimide rings is 145. In the case of a structure of pyromellitic diimide, one phthalimide ring is counted and the molecular weight thereof is 145.

The total mass of the polyimide-based resin component is calculated based on the molecular weight of the repeating unit in the polyimide-based resin. The molecular weight of a phthalimide ring portion is calculated depending on the number of bonds to other structural unit and the number of bonds in substituents, and thus is not limited to 145.

The polyimide-based resin constituting the polyimide-based resin component can be obtained by, for example, reacting a diamine and a tetracarboxylic acid, or reacting an acid chloride in addition to them. The diamine and the tetracarboxylic acid here also include respective derivatives. The “diamine” simply designated herein means any diamine and any derivative thereof, and the “tetracarboxylic acid” simply designated herein also means any derivative thereof again.

The diamine and the tetracarboxylic acid may be each used singly or in combinations of two or more kinds thereof.

The fluorinated polyimide-based resin can be obtained by using a compound having a fluorine atom in at least one of the diamine and the tetracarboxylic acid. The diamine and the tetracarboxylic acid may each have a fluorine atom.

The polyimide-based resin having a phthalimide ring can be obtained by, for example, using a compound having a phthalic anhydride structure being a tetracarboxylic acid derivative, and the diamine so that a phthalimide ring is introduced by a reaction of the diamine and the tetracarboxylic acid.

Examples of the diamine include diamine and diaminodisilane, and preferably diamine.

Examples of the diamine include an aromatic diamine, an aliphatic diamine, or a mixture thereof, and preferably include an aromatic diamine.

The aromatic diamine refers to a diamine where an amino group is directly bound to an aromatic ring, and the structure thereof may partially include an aliphatic group, an alicyclic group or other substituent. The aliphatic diamine refers to a diamine where an amino group is directly bound to an aliphatic group or an alicyclic group, and the structure thereof may partially include an aromatic group or other substituent.

Examples of the aromatic diamine include phenylenediamine, diaminotoluene, diaminobiphenyl, bis(aminophenoxy)biphenyl, diaminonaphthalene, diaminodiphenyl ether, bis[(aminophenoxy)phenyl]ether, diaminodiphenyl sulfide, bis[(aminophenoxy)phenyl]sulfide, diaminodiphenyl sulfone, bis[(aminophenoxy)phenyl]sulfone, diaminobenzophenone, diaminodiphenylmethane, bis[(aminophenoxy)phenyl]methane, bisaminophenylpropane, bis[(aminophenoxy)phenyl]propane, bisaminophenoxybenzene, bis[(amino-α,α′-dimethylbenzyl)]benzene, bisaminophenyldiisopropylbenzene, bisaminophenylfluorene, bisaminophenylcyclopentane, bisaminophenylcyclohexane, bisaminophenylnorbornane, bisaminophenyladamantane, and such any compound where one or more hydrogen atoms of the compound are each replaced with a fluorine atom or a hydrocarbon group including a fluorine atom (trifluoromethyl group or the like).

The aromatic diamine may be used singly or in combinations of two or more kinds thereof.

Examples of the phenylenediamine include m-phenylenediamine and p-phenylenediamine.

Examples of the diaminotoluene include 2,4-diaminotoluene and 2,6-diaminotoluene.

Examples of the diaminobiphenyl include benzidine (another name: 4,4′-diaminobiphenyl), o-tolidine, m-tolidine, 3,3′-dihydroxy-4,4′-diaminobiphenyl, 2,2-bis(3-amino-4-hydroxyphenyl)propane (BAPA), 3,3′-dimethoxy -4,4′-diaminobiphenyl, 3,3′-dichloro-4,4′-diaminobiphenyl, 2,2′-dimethyl-4,4′-diaminobiphenyl, and 3,3′-dimethyl -4,4′-diaminobiphenyl.

Examples of the bis(aminophenoxy)biphenyl include 4,4′-bis(4-aminophenoxy)biphenyl (BAPB), 3,3′-bis(4-aminophenoxy)biphenyl, 3,4′-bis(3-aminophenoxy)biphenyl, 4,4′-bis(2-methyl-4-aminophenoxy)biphenyl, 4,4′-bis(2,6-dimethyl-4-aminophenoxy)biphenyl, and 4,4′-bis(3-aminophenoxy)biphenyl.

Examples of the diaminonaphthalene include 2,6-diaminonaphthalene and 1,5-diaminonaphthalene.

Examples of the diaminodiphenyl ether include 3,4′-diaminodiphenyl ether and 4,4′-diaminodiphenyl ether.

Examples of the bis[(aminophenoxy)phenyl]ether include bis[4-(3-aminophenoxy)phenyl]ether, bis[4-(4-aminophenoxy)phenyl] ether, bis[3-(3-aminophenoxy)phenyl]ether, bis(4-(2-methyl-4-aminophenoxy)phenyl)ether, and bis(4-(2,6-dimethyl-4-aminophenoxy)phenyl)ether.

Examples of the diaminodiphenyl sulfide include 3,3′-diaminodiphenyl sulfide, 3,4′-diaminodiphenyl sulfide, and 4,4′-diaminodiphenyl sulfide.

Examples of the bis[(aminophenoxy)phenyl]sulfide include bis[4-(4-aminophenoxy)phenyl]sulfide, bis[3-(4-aminophenoxy)phenyl]sulfide, bis[4-(3-aminophenoxy)phenyl]sulfide, bis[3-(4-aminophenoxy)phenyl]sulfide, and bis[3-(3-aminophenoxy) phenyl] sulfide.

Examples of the diaminodiphenyl sulfone include 3,3′-diaminodiphenyl sulfone, 3,4′-diaminodiphenyl sulfone, and 4,4′-diaminodiphenyl sulfone.

Examples of the bis[(aminophenoxy)phenyl]sulfone include bis[3-(4-aminophenoxy)phenyl]sulfone, bis[4-(4-aminophenyl)]sulfone, bis[3-(3-aminophenoxy)phenyl]sulfone, bis[4-(3-aminophenyl)]sulfone, bis[4-(4-aminophenoxy)phenyl]sulfone, bis[4-(2-methyl-4-aminophenoxy)phenyl]sulfone, and bis[4-(2,6-dimethyl-4-aminophenoxy)phenyl]sulfone.

Examples of the diaminobenzophenone include 3,3′-diaminobenzophenone and 4,4′-diaminobenzophenone.

Examples of the diaminodiphenylmethane include 3,3′-diaminodiphenylmethane, 3,4′-diaminodiphenylmethane, and 4,4′-diaminodiphenylmethane.

Examples of the bis[(aminophenoxy)phenyl]methane include bis[4-(3-aminophenoxy)phenyl]methane, bis[4-(4-aminophenoxy)phenyl]methane, bis[3-(3-aminophenoxy)phenyl]methane, and bis[3-(4-aminophenoxy)phenyl]methane.

Examples of the bisaminophenylpropane include 2,2-bis(4-aminophenyl)propane, 2,2-bis(3-aminophenyl)propane, 2-(3-aminophenyl)-2-(4-aminophenyl)propane, 2,2-bis(2-methyl-4-aminophenyl)propane, and 2,2-bis(2,6-dimethyl-4-aminophenyl)propane.

Examples of the bis[(aminophenoxy)phenyl]propane include 2,2-bis[4-(2-methyl-4-aminophenoxy)phenyl]propane, 2,2-bis[4-(2,6-dimethyl-4-aminophenoxy)phenyl]propane, 2,2-bis[4-(3-aminophenoxy)phenyl]propane, 2,2-bis[4-(4-aminophenoxy)phenyl]propane, 2,2-bis[3-(3-aminophenoxy)phenyl]propane, and 2,2-bis[3-(4-aminophenoxy) phenyl] propane.

Examples of the bisaminophenoxybenzene include 1,3-bis(3-aminophenoxy)benzene, 1,3-bis(4-aminophenoxy)benzene, 1,4-bis(3-aminophenoxy)benzene, 1,4-bis(4-aminophenoxy)benzene, 1,4-bis(2-methyl-4-aminophenoxy)benzene, 1,4-bis(2,6-dimethyl-4-aminophenoxy)benzene, 1,3-bis(2-methyl-4-aminophenoxy)benzene, and 1,3-bis(2,6-dimethyl-4-aminophenoxy)benzene.

Examples of the bis(amino-α,α′-dimethylbenzyl) benzene (another name: bisaminophenyldiisopropylbenzene) include 1,4-bis(4-amino-α,α′-dimethylbenzyl)benzene (BiSAP, another name: α,α′-bis(4-aminophenyl)-1,4-diisopropylbenzene), 1,3-bis[4-(4-amino-6-methylphenoxy)-α,α′-dimethylbenzyl]benzene, α,α′-bis(2-methyl-4-aminophenyl)-1,4-diisopropylbenzene, α,α′-bis(2,6-dimethyl-4-aminophenyl)-1,4-diisopropylbenzene, α,α′-bis(3-aminophenyl)-1,4-diisopropylbenzene, α,α′-bis(4-aminophenyl)-1,3-diisopropylbenzene, α,α′-bis(2-methyl-4-aminophenyl)-1,3-diisopropylbenzene, α,α′-bis(2,6-dimethyl-4-aminophenyl)-1,3-diisopropylbenzene, and α,α′-bis(3-aminophenyl)-1,3-diisopropylbenzene.

Examples of the bisaminophenyl fluorene include 9,9-bis(4-aminophenyl)fluorene, 9,9-bis(2-methyl-4-aminophenyl)fluorene, and 9,9-bis(2,6-dimethyl-4-aminophenyl)fluorene.

Examples of the bisaminophenylcyclopentane include 1,1-bis(4-aminophenyl)cyclopentane, 1,1-bis(2-methyl-4-aminophenyl)cyclopentane, and 1,1-bis(2,6-dimethyl-4-aminophenyl)cyclopentane.

Examples of the bisaminophenylcyclohexane include 1,1-bis(4-aminophenyl)cyclohexane, 1,1-bis(2-methyl-4-aminophenyl)cyclohexane, 1,1-bis(2,6-dimethyl-4-aminophenyl)cyclohexane, and 1,1-bis(4-aminophenyl)4-methyl-cyclohexane.

Examples of the bisaminophenylnorbornane include 1,1-bis(4-aminophenyl)norbornane, 1,1-bis(2-methyl-4-aminophenyl)norbornane, and 1,1-bis(2,6-dimethyl-4-aminophenyl)norbornane.

Examples of the bisaminophenyladamantine include 1,1-bis(4-aminophenyl)adamantane, 1,1-bis(2-methyl-4-aminophenyl)adamantane, and 1,1-bis(2,6-dimethyl-4-aminophenyl)adamantane.

Examples of the aliphatic diamine include ethylenediamine, hexamethylenediamine, polyethylene glycol bis(3-aminopropyl)ether, polypropylene glycol bis(3-aminopropyl)ether, 1,3-bis(aminomethyl)cyclohexane, 1,4-bis(aminomethyl)cyclohexane, m-xylylenediamine, p-xylylenediamine, 1,4-bis(2-amino-isopropyl)benzene, 1,3-bis(2-amino-isopropyl)benzene, isophoronediamine, norbornanediamine, siloxanediamines, and such any compound where one or more hydrogen atoms of the compound are each replaced with a fluorine atom or a hydrocarbon group including a fluorine atom (trifluoromethyl group or the like).

The aliphatic diamine may be used singly or in combinations of two or more kinds thereof.

Examples of the tetracarboxylic acid include tetracarboxylic acid, tetracarboxylic acid esters, and tetracarboxylic dianhydride, and preferably include tetracarboxylic dianhydride.

Examples of the tetracarboxylic dianhydride include tetracarboxylic dianhydrides such as

pyromellitic dianhydride, 3,3′,4,4′-benzophenonetetracarboxylic dianhydride, 1,4-hydroquinonedibenzoate-3,3′,4,4′-tetracarboxylic dianhydride, 3,3′,4,4′-biphenyltetracarboxylic dianhydride, 3,3′,4,4′-diphenyl ether tetracarboxylic dianhydride (ODPA), 1,2,4,5-cyclohexanetetracarboxylic dianhydride (HPMDA), 1,2,3,4-cyclobutanetetracarboxylic dianhydride, 1,2,4,5-cyclopentanetetracarboxylic dianhydride, bicyclo[2,2,2]oct-7-ene-2,3,5,6-tetracarboxylic dianhydride, 2,3,3′,4′-biphenyltetracarboxylic dianhydride, 3,3′,4, 4′-benzophenonetetracarboxylic dianhydride, 4,4-(p -phenylenedioxy)diphthalic dianhydride, and 4,4-(m -phenylenedioxy)diphthalic dianhydride; and

2,2-bis(3,4-dicarboxyphenyl)propane, 2,2-bis(2,3-dicarboxyphenyl)propane, bis(3,4-dicarboxyphenyl)sulfone, bis(3,4-dicarboxyphenyl)ether, bis(2,3-dicarboxyphenyl) ether, 1,1-bis(2,3-dicarboxyphenyl)ethane, bis(2,3-dicarboxyphenyl)methane, and bis(3,4-dicarboxyphenyl)methane.

Examples of the tetracarboxylic dianhydride also include such any compound described above, where one or more hydrogen atoms of the compound are each replaced with a fluorine atom or a hydrocarbon group including a fluorine atom (trifluoromethyl group or the like). The tetracarboxylic dianhydride may be used singly or in combinations of two or more kinds thereof.

Examples of the acid chloride include respective acid chlorides of a tetracarboxylic acid compound, a tricarboxylic acid compound, and a dicarboxylic acid compound, and in particular, an acid chloride of a dicarboxylic acid compound is preferably used. Examples of the acid chloride of a dicarboxylic acid compound include 4,4′-oxybis(benzoyl chloride) [OBBC] and terephthaloyl dichloride (TPC).

A polyimide-based resin including a fluorine atom (hereinafter, also referred to as “fluorinated polyimide-based resin”) can be prepared by using one where at least any one of a diamine and a tetracarboxylic acid for use in preparation includes a fluorine atom.

One example of such a diamine including a fluorine atom is 2,2′-bis(trifluoromethyl)benzidine (TFMB). One example of such a tetracarboxylic acid including a fluorine atom is 4,4′-(1,1,1,3,3,3-hexafluoropropane-2,2-diyl)diphthalic dianhydride (6FDA).

The weight average molecular weight of the polyimide-based resin constituting the polyimide-based resin component is preferably 20000 or more, more preferably 50000 or more, and preferably 1000000 or less, more preferably 500000 or less.

The weight average molecular weight can be determined with a size exclusion chromatography apparatus.

On the other hand, the matrix resin 103a preferably has the property of easily forming a film from the viewpoint of film formability. In one example thereof, the matrix resin 103a is preferably a soluble resin excellent in wet film formability. A resin structure imparting the property is, for example, one having a properly bent structure in a main chain, and such a structure is obtained by, for example, a method of bending the structure by allowing the main chain to contain an ether bond, or a method of bending the structure by steric hindrance by introducing a substituent such as an alkyl group into the main chain.

### [3-3] Configuration of Temperature-Sensitive Film

The temperature-sensitive film 103 has a configuration that includes the matrix resin 103a and the plurality of conductive domains 103b contained in the matrix resin 103a. The plurality of conductive domains 103b are preferably dispersed in the matrix resin 103a. The conductive domains 103b include a conductive polymer (conjugated polymer doped with a dopant), and are preferably constituted by a conductive polymer. The plurality of conductive domains 103b are contained in, preferably dispersed in the matrix resin 103a, resulting in a tendency to elongate the distance of hopping. The distance of hopping is elongated to result in an increase in resistance value, and thus the amount of change in electric resistance value detected is mainly derived from hopping conduction. Thus, the electric resistance value per unit temperature exhibited by the temperature-sensitive film 103 can be increased, resulting in an increase in accuracy of temperature measurement of the temperature sensor element.

The total content of the conjugated polymer and the dopant in the temperature-sensitive film 103 is preferably 90% by mass or less, more preferably 80% by mass or less, further preferably 70% by mass or less, still further preferably 60% by mass or less based on 100% by mass of the total amount of the matrix resin 103a, the conjugated polymer and the dopant, from the viewpoint of effective suppression of penetration of moisture into the temperature-sensitive film 103. If the total content of the conjugated polymer and the dopant is more than 90% by mass, the content of the matrix resin 103a in the temperature-sensitive film 103 is low, resulting in a tendency to deteriorate the effect of suppressing penetration of moisture into the temperature-sensitive film 103.

The total content of the conjugated polymer and the dopant in the temperature-sensitive film 103 is preferably 5% by mass or more, more preferably 10% by mass or more, further preferably 20% by mass or more, still further preferably 30% by mass or more based on 100% by mass of the total amount of the matrix resin 103a, the conjugated polymer and the dopant, from the viewpoint of a reduction in power consumption of the temperature sensor element and from the viewpoint of a normal operation of the temperature sensor element.

A low total content of the conjugated polymer and the dopant results in a tendency to increase the electric resistance, sometimes leading to an increase in current necessary for measurement and thus a remarkably increase in power consumption. A low total content of the conjugated polymer and the dopant also sometimes provides no communication between the electrodes. A low total content of the conjugated polymer and the dopant sometimes causes Joule heat to be generated depending on the current flowing, and also sometimes makes temperature measurement by itself difficult. Accordingly, the total content of the conjugated polymer and the dopant, which enables the conductive polymer to be formed, is preferably in the above range.

The thickness of the temperature-sensitive film 103 is not particularly limited, and is, for example, 0.3 μm or more and 50 μm or less. The thickness of the temperature-sensitive film 103 is preferably 0.3 μm or more and 40 μm or less from the viewpoint of flexibility of the temperature sensor element.

### [3-4] Production of Temperature-Sensitive Film

The temperature-sensitive film 103 is obtained by stirring and mixing the conjugated polymer, the dopant, the matrix resin (for example, thermoplastic resin), and a solvent to thereby prepare a polymer composition for a temperature-sensitive film, and forming the composition into a film. Examples of the film formation method include a method involving applying the polymer composition for a temperature-sensitive film onto the substrate 104, and then drying and, if necessary, heat-treating the resultant. The method of applying the polymer composition for a temperature-sensitive film is not particularly limited, and examples include a spin coating method, a screen printing method, an ink-jet printing method, a dip coating method, an air knife coating method, a roll coating method, a gravure coating method, a blade coating method, and a dropping method.

In a case where the matrix resin 103a is formed from an active energy ray-curable resin or a thermosetting resin, a curing treatment is further applied. In a case where an active energy ray-curable resin or a thermosetting resin is used, no solvent may be required to be added to the polymer composition for a temperature-sensitive film, and in this case, no drying treatment is also required.

The polymer composition for a temperature-sensitive film usually allows the conjugated polymer and the dopant to form conductive polymer domains (conductive domains). The polymer composition for a temperature-sensitive film preferably includes the matrix resin because such conductive domains are more dispersed in the composition than those in a case where no matrix resin is included, and conduction between such conductive polymer domains easily serves as hopping conduction and the electric resistance value can be accurately detected.

The content of the matrix resin in the polymer composition (excluding the solvent) for a temperature-sensitive film is preferably substantially the same as the content of the matrix resin in the temperature-sensitive film 103 formed from the composition. The content of each component included in the polymer composition for a temperature-sensitive film corresponds to the content of each component relative to the total of each component in the polymer composition for a temperature-sensitive film, excluding the solvent, and is preferably substantially the same as the content of each component in the temperature-sensitive film 103 formed from the polymer composition for a temperature-sensitive film.

The solvent included in the polymer composition for a temperature-sensitive film is preferably a solvent that can dissolve the conjugated polymer, the dopant and the matrix resin, from the viewpoint of film formability.

The solvent is preferably selected depending on, for example, the solubilities in the conjugated polymer, the dopant and the matrix resin used.

Examples of such a usable solvent include N-methyl -2-pyrrolidone, N,N-dimethylacetamide, N,N -diethylacetamide, N,N-dimethylformamide, N,N -diethylformamide, N-methylcaprolactam, N-methylformamide, N,N,2-trimethylpropionamide, hexamethylphosphoramide, tetramethylenesulfone, dimethylsulfoxide, m-cresol, phenol, p-chlorophenol, 2-chloro-4-hydroxytoluene, diglyme, triglyme, tetraglyme, dioxane, γ-butyrolactone, dioxolane, cyclohexanone, cyclopentanone, 1,4-dioxane, caprolactam, dichloromethane, and chloroform.

The solvent may be used singly or in combinations of two or more kinds thereof.

The polymer composition for a temperature-sensitive film may include one or more additives such as an antioxidant, a flame retardant, a plasticizer, and an ultraviolet absorber.

The total content of the conjugated polymer, the dopant and the matrix resin in the polymer composition for a temperature-sensitive film is preferably 90% by mass or more based on the solid content (all components other than the solvent) of the polymer composition for a temperature-sensitive film, of 100% by mass. The total content is more preferably 95% by mass or more, further preferably 98% by mass or more, and may be 100% by mass.

### [4] Temperature Sensor Element

The temperature sensor element can include any constituent component other than the above constituent components. Examples of such other constituent component include those commonly used for temperature sensor elements, such as an electrode, an insulation layer, and a sealing layer that seals the temperature-sensitive film.

The temperature sensor element including the temperature-sensitive film is hardly affected by a humidity condition of an environment where the element is placed, and can more reliably measure the temperature than a conventional temperature sensor element. This can be evaluated by measuring the variation in electric resistance value of the temperature sensor element due to the change in humidity environment, and can be evaluated according to, for example, the following method.

First, the temperature sensor element is left to still stand under an environment at room temperature and normal humidity (about 40 to 60% RH) for a certain time. Thereafter, the pair of electrodes of the temperature sensor element and a commercially available digital multimeter are connected with a lead wire, and the electric resistance value R1 under such an environment is measured. Next, the temperature sensor element is left to still stand under an environment at the same temperature and a lower relative humidity, and the electric resistance value R2 under this environment is measured. In Examples described below, the electric resistance value 1 is measured after the temperature sensor element is left to still stand under an environment at a temperature of 30° C. and a relative humidity of 60% RH for 15 hours, and the electric resistance value 2 is measured after the temperature sensor element is then left to still stand under an environment at a temperature of 30° C. and a relative humidity of 30% RH for 1 hour.

The electric resistance values measured as above are plugged in the following expression, and the rate of change r (%) in electric resistance value can be determined.

r (%)=100×(|R1−R2|/R1)

A smaller numerical value of the rate of change r (%) means that, even after still standing under a higher humidity environment for a long time and thereafter still standing under a lower humidity environment, the difference between the electric resistance values measured under the respective humidity environments is smaller. The temperature sensor element detects such each electric resistance value as the change in temperature, and thus the temperature sensor element can more reliably measure the temperature with no influence by the change in humidity.

The rate of change r (%) is preferably 1% or less, more preferably 0.9% or less, further preferably 0.7% or less. The rate of change r (%) is more preferably closer to 0%. The rate of change r (%) is preferably in the above range because the temperature sensor element including the temperature-sensitive film tends to be able to more reliably measure the temperature with no influence by the change in humidity.

### EXAMPLES

Hereinafter, the present invention is further specifically described with reference to Examples, but the present invention is not limited to these Examples at all. In Examples, “%” and “part(s)” representing any content or amount of use are on a mass basis, unless particularly noted.

### Production Example 1: Preparation of Dedoped Polyaniline

A dedoped polyaniline was prepared by preparing and dedoping a polyaniline doped with hydrochloric acid, as shown in the following [1] and [2].

### [1] Preparation of Polyaniline Doped with Hydrochloric Acid

A first aqueous solution was prepared by dissolving 5.18 g of aniline hydrochloride (manufactured by Kanto Kagaku) in 50 mL of water. A second aqueous solution was prepared by dissolving 11.42 g of ammonium persulfate (manufactured by Fujifilm Wako Pure Chemical Corporation) in 50 mL of water.

Next, the first aqueous solution was stirred using a magnetic stirrer at 400 rpm for 10 minutes with the temperature being regulated at 35° C., and thereafter, the second aqueous solution was dropped to the first aqueous solution at a dropping speed of 5.3 mL/min under stirring at the same temperature. After the dropping, a reaction was further allowed to occur for 5 hours with a reaction liquid being kept at 35° C., and thus a solid was precipitated in the reaction liquid.

Thereafter, the reaction liquid was filtered by suction with a paper filter (second kind for chemical analysis in JIS P 3801), and the resulting solid was washed with 200 mL of water. Thereafter, the solid was washed with 100 mL of 0.2 M hydrochloric acid and then 200 mL of acetone, and thereafter dried in a vacuum oven, thereby obtaining a polyaniline doped with hydrochloric acid, represented by the following formula (1).

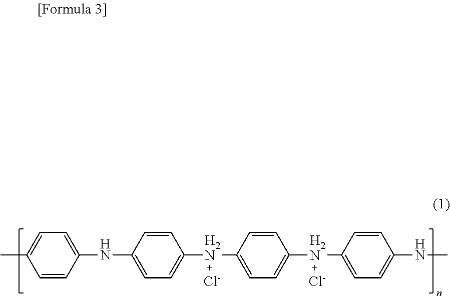

### [2] Preparation of Dedoped Polyaniline

Four g of the polyaniline doped with hydrochloric acid, obtained in [1], was dispersed in 100 mL of 12.5% by mass ammonia water and the resultant was stirred with a magnetic stirrer for about 10 hours, thereby precipitating a solid in a reaction liquid.

Thereafter, the reaction liquid was filtered by suction with a paper filter (second kind for chemical analysis in JIS P 3801), and the resulting solid was washed with 200 mL of water and then 200 mL of acetone. Thereafter, the solid was dried in vacuum at 50° C., thereby obtaining a dedoped polyaniline represented by the following formula (2). The dedoped polyaniline was dissolved in N-methylpyrrolidone (NMP; Tokyo Chemical Industry Co., Ltd.) so that the concentration was 5% by mass, thereby preparing a solution of the dedoped polyaniline (conjugated polymer).

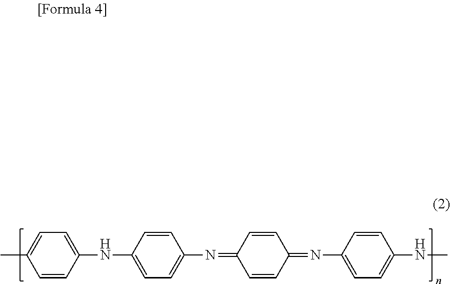

### Production Example 2: Preparation of Matrix Resin 1

A powder of polyimide having a repeating unit represented by the following formula (5) was produced using 2,2′-bis(trifluoromethyl)benzidine (TFMB) represented by the following formula (3), as a diamine, and 4,4′-(1,1,1,3,3,3-hexafluoropropane-2,2-diyl)diphthalic dianhydride (6FDA) represented by the following formula (4), as a tetracarboxylic dianhydride, according to the description in Example 1 of International Publication No. WO 2017/179367.

The powder was dissolved in propylene glycol 1-monomethyl ether 2-acetate so that the concentration was 8% by mass, thereby preparing polyimide solution (1). In the following Examples, polyimide solution (1) was used as matrix resin 1.

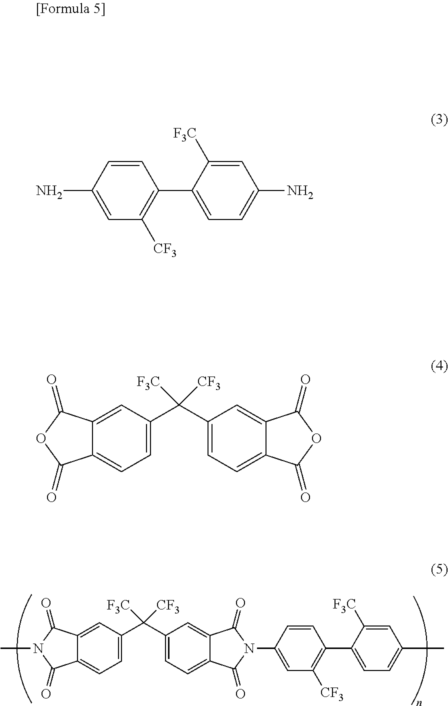

### Production Example 3: Preparation of Matrix Resin 2

4,4′-Bis(4-aminophenoxy)biphenyl (BAPB) represented by the following formula (6) and 1,4-bis(4-amino-α,α-dimethylbenzyl)benzene (BiSAP) represented by the following formula (7), as diamines, and 1,2,4,5-cyclohexanetetracarboxylic dianhydride (HPMDA) represented by the following formula (8), as a tetracarboxylic dianhydride, were used. A polyimide solution was obtained according to the description in Synthesis Example 2 of Japanese Patent Laid-Open No. 2016-186004 except that the molar ratio of BAPB:BiSAP:HPMDA was 0.5:0.5:1, and a polyimide powder was obtained according to the description in Example 2 of the Publication.

The powder was dissolved in γ-butyrolactone so that the concentration was 8% by mass, thereby preparing polyimide solution (2). In the following Examples, polyimide solution (2) was used as matrix resin 2.

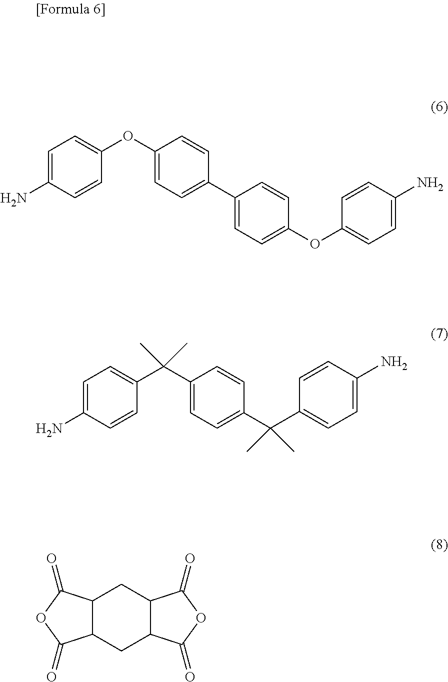 [SMILES: Nc1ccc(Oc2ccc(-c3ccc(Oc4ccc(N)cc4)cc3)cc2)cc1 ; CC(C)(c1ccc(N)cc1)c1ccc(C(C)(C)c2ccc(N)cc2)cc1 ; O=C1OC(=O)C2CC3C(=O)OC(=O)C3CC12]

### Example 1

### [1] Preparation of Polymer Composition for Temperature-Sensitive Film

A polymer composition for a temperature-sensitive film was prepared by mixing 0.500 g of a solution of the dedoped polyaniline prepared in Production Example 1, 0.920 g of NMP (Tokyo Chemical Industry Co., Ltd.), 0.730 g of polyimide solution (1) as matrix resin 1, and 0.026 g of (+)-camphorsulfonic acid (Tokyo Chemical Industry Co., Ltd.) as a dopant.

### [2] Production of Temperature Sensor Element

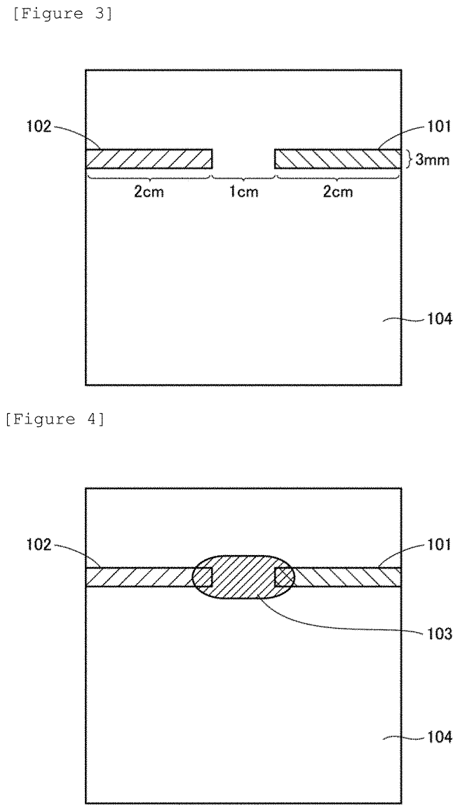

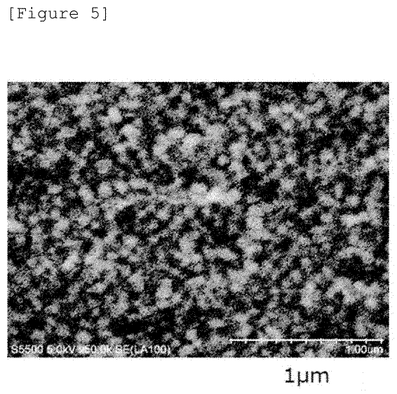

The production procedure of a temperature sensor element is described with reference to FIG. 3 and FIG. 4.

A pair of rectangular Au electrodes of 2 cm in length×3 mm in width was formed on one surface of a glass substrate (“Eagle XG” manufactured by Corning Incorporated) of a 5-cm square by sputtering using Ioncoater (“IB-3” manufactured by Eiko Corporation), with reference to FIG. 3.

The thickness of each of the Au electrodes according to cross section observation with a scanning electron microscope (SEM) was 200 nm.

Next, 200 μL of the polymer composition for a temperature-sensitive film, prepared in [1], was dropped between the pair of Au electrodes formed on the glass substrate, with reference to FIG. 4. A film of the polymer composition for a temperature-sensitive film, formed by the dropping, was in contact with both the electrodes. Thereafter, the film was subjected to a drying treatment at 50° C. under normal pressure for 2 hours and then at 50° C. under vacuum for 2 hours, and thereafter a heat treatment at 100° C. for about 1 hour, thereby forming a temperature-sensitive film and producing a temperature sensor element. The thickness of the temperature-sensitive film was measured with Dektak KXT (manufactured by Bruker), and was 30 μm.

### Example 2

A polymer composition for a temperature-sensitive film was prepared in the same manner as in Example 1 except that 0.730 g of polyimide solution (1) of Example 1 was changed to 0.520 g of polyimide solution (1) and 0.210 g of polyimide solution (2). A temperature-sensitive film was formed and a temperature sensor element was produced in the same manner as in Example 1 except that the polymer composition for a temperature-sensitive film was used. The thickness of the temperature-sensitive film was measured in the same manner as in Example 1, and was 30 μm.

### Example 3

A polymer composition for a temperature-sensitive film was prepared in the same manner as in Example 1 except that 0.730 g of polyimide solution (1) of Example 1 was changed to 0.210 g of polyimide solution (1) and 0.520 g of polyimide solution (2). A temperature-sensitive film was formed and a temperature sensor element was produced in the same manner as in Example 1 except that the polymer composition for a temperature-sensitive film was used. The thickness of the temperature-sensitive film was measured in the same manner as in Example 1, and was 30 μm.

### Example 4

A polymer composition for a temperature-sensitive film was prepared in the same manner as in Example 1 except that 0.730 g of polyimide solution (1) of Example 1 was changed to 0.100 g of polyimide solution (1) and 0.630 g of polyimide solution (2). A temperature-sensitive film was formed and a temperature sensor element was produced in the same manner as in Example 1 except that the polymer composition for a temperature-sensitive film was used. The thickness of the temperature-sensitive film was measured in the same manner as in Example 1, and was 30 μm.

### Example 5

A polymer composition for a temperature-sensitive film was prepared in the same manner as in Example 1 except that 0.730 g of polyimide solution (1) of Example 1 was changed to 0.420 g of polyimide solution (1) and 0.310 g of polyimide solution (2). A temperature-sensitive film was formed and a temperature sensor element was produced in the same manner as in Example 1 except that the polymer composition for a temperature-sensitive film was used. The thickness of the temperature-sensitive film was measured in the same manner as in Example 1, and was 30 μm.

### Example 6

A polymer composition for a temperature-sensitive film was prepared in the same manner as in Example 1 except that 0.730 g of polyimide solution (1) of Example 1 was changed to 0.310 g of polyimide solution (1) and 0.420 g of polyimide solution (2). A temperature-sensitive film was formed and a temperature sensor element was produced in the same manner as in Example 1 except that the polymer composition for a temperature-sensitive film was used. The thickness of the temperature-sensitive film was measured in the same manner as in Example 1, and was 30 μm.

### Comparative Example 1

A polymer composition for a temperature-sensitive film was prepared in the same manner as in Example 1 except that 0.730 g of polyimide solution (1) of Example 1 was changed to 0.730 g of polyimide solution (2). A temperature-sensitive film was formed and a temperature sensor element was produced in the same manner as in Example 1 except that the polymer composition for a temperature-sensitive film was used. The thickness of the temperature-sensitive film was measured in the same manner as in Example 1, and was 30 μm.

Table 1 shows the respective content rates (% by mass) of matrix resins 1 and 2 based on the solid content of each of the polymer compositions for a temperature-sensitive film, prepared in Examples 1 to 6 and Comparative Example 1, of 100% by mass. The solid content of each of the polymer compositions for a temperature-sensitive film refers to the total of components other than the solvent.

The content rate of the dedoped polyaniline (conjugated polymer) based on the solid content of each of the polymer compositions for a temperature-sensitive film, prepared in Examples 1 to 6 and Comparative Example 1, of 100% by mass was 23.1% by mass.

FIG. 5 illustrates a SEM photograph imaging a cross section of the temperature-sensitive film in the temperature sensor element produced in Example 1. A white-photographed portion corresponded to conductive domains dispersed in the matrix resin.

### Content Rate of Fluorine in Matrix Resin

The content rate (% by mass) of fluorine in the matrix resin constituting the temperature-sensitive film, in each of Examples 1 to 6 and Comparative Example 1, was calculated as follows. The results are shown in Table 1.

Matrix resin 2 was a resin having structural units represented by the formulae (6), (7) and (8) and had no fluorine atom in its structure, and thus the content rate of fluorine was 0% by mass. Accordingly, the content rate (% by mass) of fluorine in the matrix resin in Comparative Example 1 was 0% by mass.

Matrix resin 1 was a resin having the repeating unit represented by the formula (5), and the content rate of a fluorine atom in the structure of the repeating unit relative to the amount of all atoms in the structure was calculated based on the structure. The molecular weight per repeating unit was 728 and the atomic weight of fluorine was 19, and the content rate of fluorine of matrix resin 1 was calculated from these weights and the number (12) of fluorine atoms in the repeating unit, and was 31.3% by mass. Accordingly, the content rate (% by mass) of fluorine in the matrix resin in Example 1 was 31.3% by mass.

Matrix resins 1 and 2 were mixed and used in each of Examples 2 to 6. Thus, the content rate Z (% by mass) of fluorine in the total amount of the matrix resins was calculated according to the following expression under the assumption that the respective content rates of matrix resins 1 and 2 in the total amount of the matrix resins are defined as X (% by mass) and Y (% by mass), respectively.

Content rate Z of fluorine in total amount of matrix resins=X/(X+Y)×31.3

### Content Rate of Fluorine in Temperature-Sensitive Film

The content rate of fluorine in the temperature-sensitive film was calculated according to the following expression. Z in the expression was the same as that described with respect to the above content rate of fluorine in the matrix resins. W was the content rate (% by mass) of the resin in the temperature-sensitive film. The results are shown in Table 1.

Content rate (% by mass) of fluorine in temperature-sensitive film=W×Z

The respective content rates of fluorine in the temperature-sensitive films of Example 1 and Example 4 were measured using the above combustion ion chromatographic method, and were 14.2% by mass and 2.1% by mass, respectively.

### Calculation of Content Rate of Phthalimide Ring in Matrix Resin

In calculation, the molecular weight of a phthalimide ring was 145, the molecular weight of the repeating unit of matrix resin 1 was 728, the molecular weight of the repeating unit of matrix resin 2 was 545, the number of phthalimide rings in the repeating unit of matrix resin 1 was 2, and the number of phthalimide rings in the repeating unit of matrix resin 2 was 0. The content rate of a phthalimide ring in each matrix resin used in Examples and Comparative Examples was calculated based on the respective amounts of matrix resin 1 and matrix resin 2 included in each of the polymer compositions for a temperature-sensitive film. Specifically, the content rate of a phthalimide ring (% by mass) in each matrix resin was calculated according to the following expression under the assumption that the content of matrix resin 1 was defined as A (g) and the content of matrix resin 2 was defined as B (g). The respective contents of matrix resin 1 and matrix resin 2 were the amounts of polyimides included in polyimide solutions 1 and 2.

Content rate of phthalimide ring in matrix resin=100×(145×2×A)/[728×(A+B)]

### Evaluation of Temperature Sensor Element

The temperature sensor element was evaluated by evaluating the influence of the change in humidity environment where the temperature sensor element was placed, on the instruction value (electric resistance value) indicated by the temperature sensor element. Specifically, the evaluation was performed as follows.

The temperature sensor element was left to still stand under an environment at a temperature of 30° C. and a relative humidity of 60% RH for 15 hours. Thereafter, the pair of Au electrodes of the temperature sensor element and a digital multimeter (“B35T+” manufactured by OWON Japan) were connected with a lead wire, and the electric resistance value R60 of the temperature sensor element was measured under an environment at a temperature of 30° C. and a relative humidity of 60% RH.

Thereafter, the temperature sensor element was left to still stand under an environment at a temperature of 30° C. and a relative humidity of 30% RH for 1 hour, and the electric resistance value R30 was measured under an environment at a temperature of 30° C. and a relative humidity of 30% RH.

The rate of change r (%) of the electric resistance value was determined according to the following expression. The results are shown in Table 1.

r (%)=100×(|R60−R30|/R60)

A lower rate of change r (%) in the expression corresponded to a more suppressed variation in electric resistance value due to the change in humidity environment even after still standing under a high humidity environment for a long time. In other words, temperature measurement could be made with no influence by any humidity.

TABLE 1

| | Content rate | | | | | Rate of |
|---|---|---|---|---|---|---|
| | (% by mass) of | Matrix resin | | | | change r (%) |
| | fluorine atom | Content rate | Content rate | Content rate | Content rate | in electric |
| | in temperature- | (% by mass) of | (% by mass) of | (% by mass) of | (% by mass) of | resistance |
| | sensitive film | matrix resin 1 | matrix resin 2 | fluorine atom | phthalimide ring | value |
| Example 1 | 16.8 | 53.8 | 0 | 31.3 | 39.8 | 0.04 |
| Example 2 | 12.1 | 38.5 | 15.3 | 22.4 | 28.4 | 0.07 |
| Example 3 | 4.8 | 15.4 | 38.4 | 8.9 | 11.4 | 0.86 |
| Example 4 | 2.4 | 7.6 | 46.2 | 4.5 | 5.7 | 0.74 |
| Example 5 | 9.6 | 30.8 | 23.1 | 17.9 | 22.7 | 0.15 |
| Example 6 | 7.2 | 23.1 | 30.8 | 13.4 | 17.1 | 0.30 |
| Comparative | 0 | 0 | 53.8 | 0 | 0 | 1.19 |
| Example 1 | | | | | | |

### REFERENCE SINGS LIST

100 temperature sensor element, 101 first electrode, 102 second electrode, 103 temperature-sensitive film, 103a matrix resin, 103b conductive domain, 104 substrate.

1. A temperature sensor element comprising a pair of electrodes and a temperature-sensitive film disposed in contact with the pair of electrodes, wherein
the temperature-sensitive film comprises a fluorine atom and the temperature-sensitive film comprises a matrix resin and a plurality of conductive domains contained in the matrix resin, and
the conductive domains comprise a conductive polymer.

2. The temperature sensor element according to claim 1, wherein the matrix resin contains a fluorine atom.

3. The temperature sensor element according to claim 1, wherein a content rate of a fluorine atom in the temperature-sensitive film is 1% by mass or more based on a total mass of the temperature-sensitive film of 100% by mass.

4. The temperature sensor element according to claim 1, wherein a content rate of fluorine in the matrix resin is 4% by mass or more based on a total mass of the matrix resin of 100% by mass comprised in the temperature-sensitive film.

5. The temperature sensor element according to claim 1, wherein the matrix resin comprises a polyimide-based resin component.

6. The temperature sensor element according to claim 5, wherein a content rate of a phthalimide ring in the polyimide-based resin component is 5% by mass or more based on a total mass of the polyimide-based resin component of 100% by mass.
